(19) United States
(12) Patent Application Publication
(10) Pub. No.: US 2008/0022401 A1
(43) Pub. Date: Jan. 24, 2008

(54) Apparatus and Method for Multicore Network Security Processing

(75) Inventors: Craig Cameron, Forrest (AU); Teewoon Tan, Roseville (AU); Darren Williams, Newtown (AU); Robert Matthew Barrie, Double Bay (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sensory Networks Inc., Palo Alto, CA (US)

(21) Appl. No.: 11/459,280

(22) Filed: Jul. 21, 2006

(51) Int. Cl. G06F 12/14

(52) U.S. Cl. 726/22

(57) ABSTRACT

A multicore network security system includes scheduler modules, one or more security modules and post-processing modules. Each security module may be a processing core or itself a network security system. A scheduler module routes input data to the security modules, which perform network security functions, then routes processed data to one or more post-processing modules. The post-processing modules post-process this processed data and route it back to scheduler modules. If further processing is required, the processed data is routed to the security modules; otherwise the processed data is output from the scheduler modules. Each processing core may operate independently from other processing cores, enabling parallel and simultaneous execution of network security functions.

### CROSS REFERENCE TO RELATED APPLICATIONS

The present application is related to U.S. application Ser. No. 10/799,367, filed Mar. 12, 2004, entitled “Apparatus And Method For Memory Efficient, Programmable, Pattern Matching Finite State Machine Hardware” commonly assigned; U.S. application Ser. No. 10/850,978, filed May 21, 2004, entitled “Apparatus And Method For Large Hardware Finite State Machine With Embedded Equivalence Classes” commonly assigned; U.S. application Ser. No. 10/850,979, filed May 21, 2004, entitled “Efficient Representation Of State Transition Tables” commonly assigned; the contents of all of which are incorporated herein by reference in their entirety.

### BACKGROUND OF THE INVENTION

The present invention relates generally to the area of network security. More specifically, the present invention relates to systems and methods for multicore network security processing.

Today, electronic messaging, such as email, Instant Messaging and Internet Relay Chatting, and information retrieval, such as World Wide Web surfing and Rich Site Summary streaming, have become essential uses of communication networks for conducting both business and personal affairs. The proliferation of the Internet as a global communications medium has resulted in electronic messaging becoming a convenient form of communication and has also resulted in online information databases becoming a convenient means of distributing information. Rapidly increasing user demand for such network services has led to rapidly increasing levels of data traffic and consequently a rapid expansion of network infrastructure to process this data traffic.

The fast rate of Internet growth, together with the high level of complexity required to implement the Internet's diverse range of communication protocols, has contributed to a rise in the vulnerability of connected systems to attack by malicious systems. Successful attacks exploit system vulnerabilities and, in doing so, exploit legitimate users of the network. For example, a security flaw within a web browser may allow a malicious attacker to gain access to personal files on a computer system by constructing a webpage specially designed to exploit the security flaw when accessed by that specific web browser. Likewise, security flaws in email client software and email routing systems can be exploited by constructing email messages specially designed to exploit the security flaw. Following the discovery of a security flaw, it is critically important to block malicious traffic as soon as possible such that the damage is minimized.

Differentiating between malicious and non-malicious traffic is often difficult. Indeed, a system connected to a network may be unaware that a successful attack has even taken place. Worms and viruses replicate and spread themselves to vast numbers of connected systems by silently leveraging the transport mechanisms installed on the infected connected system, often without user knowledge or intervention. For example, a worm may be designed to exploit a security flaw on a given type of system and infect these systems with a virus. This virus may use an email client pre-installed on infected systems to autonomously distribute unsolicited email messages, including a copy of the virus as an attachment, to all the contacts within the client's address book.

Minimizing the number of unsolicited electronic messages, aka spam, is another content security related problem. Usually as a means for mass advertising, the sending of spam leverages the minimal cost of transmitting electronic messages over a network, such as the Internet. Unchecked, spam can quickly flood a user's electronic inbox, degrading the effectiveness of electronic messaging as a communications medium. In addition, spam may contain virus infected or spy-ware attachments.

Electronic messages and World Wide Web pages are usually constructed from a number of different components, where each component can be further composed of subcomponents, and so on. This feature allows, for example, a document to be attached to an email message, or an image to be contained within a webpage. The proliferation of network and desktop applications has resulted in a multitude of data encoding standards for both data transmission and data storage. For example, binary attachments to email messages can be encoded in Base64, Uuencode, Quoted-Printable, BinHex, or a number of other standards. Email clients and web browsers must be able to decompose the incoming data and interpret the data format in order to correctly render the content.

To combat the rise in security exploits, a number of network service providers and network security companies provide products and applications to detect malicious web content; malicious email and instant messages; and spam email. Referred to as content security applications, these products typically scan through the incoming web or electronic message data looking for patterns which indicate malicious content. Scanning network data can be a computationally expensive process involving decomposition of the data and rule matching against each component. Statistical classification algorithms and heuristics can also be applied to the results of the rule matching process. For example, an incoming email message being scanned by such a system could be decomposed into header, message body and various attachments. Each attachment may then be further decoded and decomposed into subsequent components. Each individual component is then scanned for a set of predefined rules. For example, spam emails may include patterns such as “click here” or “make money fast”.

As network traffic increases, content security systems deployed to provide security in communication systems are becoming over-burdened with large volumes of data and are rapidly becoming a performance bottleneck. Security engines need to operate faster to deal with ever increasing network speeds, network complexity, and growing taxonomy of threats.

Network security systems are increasingly unable to run multiple content security applications, leading to a division of applications across multiple independent security systems. In some cases, to avoid the bottleneck, network security administrators are turning off key application functionality, defeating the effectiveness of the security applications. What is needed is a high performance network security system.

### BRIEF SUMMARY OF THE INVENTION

According to the present invention, techniques for network security systems are provided. More particularly, the invention provides a method and system for operating network security systems at high speeds. Merely by way of example, the invention may be applied to networking devices that have been distributed throughout local, wide area, and world wide area networks, any combination of these, and the like. Such networking devices include computers, servers, routers, bridges, firewalls, network security appliances, unified threat management appliances (UTM), any combination of these, and the like.

In one embodiment, the present invention provides a system for performing network security functions. The system has a first computing system and second computing system, where the first computing system is configured to operate a network security application. The second computing system has second scheduler modules configured to receive data streams from the first computing system. Merely by way of example, the network security application may perform one or more of the functions of an anti-virus, anti-spam, anti-spyware, intrusion detection, intrusion prevention, content security, content filtering, XML-based parsing and filtering system. The first computing system is coupled to the second computing system via a connector region. Merely by way of example, connector regions include Peripheral Component Interconnect (PCI), PCI-X, PCI Express, InfiniBand, Universal Serial Bus (USB), IEEE 1394 high-speed serial data bus (FireWire), wireless, network, custom data bus, and general data bus interfaces. On receiving data streams from the first computing system, the second scheduler modules provided by the second computing system generate one or more scheduled data streams and one or more output data streams. In one embodiment, the second computing system has at least one security module configured to receive the one or more scheduled data streams, and in response the security module generates one or more processed data streams. In another embodiment, the second computing system has at least one security module configured to receive the one or more scheduled data streams or one or more processed data streams, and in response the security module generates one or more processed data streams. The second computing system has second post-processing modules configured to post-process the one or more processed data streams to generate and output post-processed data streams.

In one embodiment, the first computing system has first scheduler modules configured to communicate data and control signals to and from the second scheduler modules. The first scheduler modules is configured to receive one or more input data streams from the network security application and to operate with the second scheduler modules to generate one or more scheduled data streams and one or more output data streams. The first computing system also has first post-processing modules configured to communicate data and control signals to and from the second post-processing modules. The first post-processing modules are configured to post-process the one or more processed data streams to generate and output post-processed data streams.

In one embodiment, security modules include a memory. The memory is used to store input data, temporary data, or processed data. In one embodiment, the second computing system includes another memory, where the memory is coupled to the second scheduler modules, security modules and/or second post-processing modules. This memory is used to store input data, temporary data, or processed data. In one embodiment, the first computing system includes a first computing system memory, where the first computing system memory is coupled to the second scheduler modules and/or second post-processing modules. The first computing system memory is used to store input data, temporary data, processed data, or post-processed data. Merely by way of example, temporary data includes temporary variables used during computations.

In one embodiment, the security modules include in part one or more processing cores, where the processing cores are configured to perform network security functions. In one embodiment, the processing cores include processing units within a central processing unit (CPU). In another embodiment, the processing cores include fragment processors and/or vertex processors within a graphics processing unit (GPU). In this embodiment, the second scheduler modules and second post-processing modules are provided at least in part by a graphics processing unit (GPU).

In one embodiment, security modules include dedicated network security hardware devices. Merely by way of example, a dedicated network security hardware device includes programmable devices, programmable processors, reconfigurable hardware logics, such as those provided by a field programmable gate array (FPGA), application specific integrated circuit (ASIC), custom integrated circuits, any combination of these, and the like. The dedicated network security hardware includes in part one or more processing cores.

In one embodiment, a security module includes one or more multicore network security systems. A hierarchical multicore network security system is produced in this manner, where a security module includes other security modules.

In a specific embodiment, the present invention provides a method for performing network security functions, e.g., pattern matching, encoding, decoding, encrypting, decrypting, and parsing. The method includes operating a network security application provided by a first computing system. Merely by way of example, a network security application, such as an anti-virus and anti-spam application, may execute on a first computing system, such as a network security appliance or a CPU-based computer. The method includes receiving data streams from the first computing system, and generating one or more scheduled data streams and one or more output data streams. In one embodiment, the method includes receiving one or more scheduled data streams. In another embodiment, the method includes receiving one or more processed data streams generated by a post-processing module. In either embodiment, the method includes generating one or more processed data streams, post-processing the one or more processed data streams, and generating and outputting post-processed data streams.

In a specific embodiment, the present invention provides a method for performing network security functions, e.g., pattern matching, encoding, decoding, encrypting, decrypting, and parsing. The method includes receiving input data streams from a network security application. Examples of a network security application include anti-virus, anti-spam, anti-spyware, intrusion detection, intrusion prevention, content security, content filtering, XML-based parsing and filtering applications. The method includes processing input data streams to generate processed input data, selectively scheduling processed input data onto scheduled data streams using scheduler modules, selectively scheduling processed input data for transmission to network security applications using scheduler modules, transmitting scheduled data streams to security modules, processing schedule data streams, receiving processed data, processing processed data to generate partially post-processed data, selectively transmitting partially post-processed data to scheduler modules, selectively transmitting partially post-processed data to the network security application, processing partially post-processed data to generate fully post-processed data, selectively transmitting fully post-processed data to schedule modules, and/or selectively transmitting fully post-processed data to the network security application.

In one embodiment, processing cores are used for receiving, generating and post-processing data streams. In one embodiment, the processing cores include processing units within a central processing unit (CPU). In another embodiment, the processing cores include fragment processors and/or vertex processors within a graphics processing unit (GPU).

### BRIEF DESCRIPTION OF THE DRAWINGS

FIG. 1 depicts logical processing blocks of a multicore network security system, in accordance with an embodiment of the present invention.

FIG. 2 depicts logical processing blocks of a multicore network security system, in accordance with another embodiment of the present invention.

FIG. 3 depicts logical processing blocks of a multicore network security system, in accordance with another embodiment of the present invention.

FIG. 4 depicts logical blocks of a security module shown in FIGS. 1-3, in accordance with an embodiment of the present invention.

FIG. 5 depicts logical blocks of a multicore network security system comprising a first computing system and a second computing system, in accordance with another embodiment of the present invention.

FIG. 6 depicts logical blocks of a multicore network security system comprising a first computing system and a second computing system, in accordance with another embodiment of the present invention.

FIG. 7 depicts logical blocks of a multicore network security system comprising a first computing system and a second computing system, in accordance with another embodiment of the present invention.

FIG. 8 depicts a flowchart of the operation of a multicore network security system, in accordance with an embodiment of the present invention.

### DETAILED DESCRIPTION OF THE INVENTION

According to the present invention, techniques for operating network security applications are provided. More specifically, the invention provides for methods and apparatus to operate security applications and networked devices by using more than one processing cores. Merely by way of example, content security applications include anti-virus filtering, anti spam filtering, anti spyware filtering, XML-based, VoIP filtering, and web services applications. Merely by way of example, networked devices include gateway unified threat management (UTM), anti-virus, intrusion detection, intrusion prevention, email filtering and network data filtering appliances.

The present invention discloses an apparatus for performing network security functions using multiple security modules. A security module includes in part a processing core. A processing core is an execution unit configured to carry out a network security operation independently of other execution units. A security module includes one or more processing cores, and a security module itself may be treated as a processing core. To enable network security functions to be processed by multiple processing cores, a network security system apparatus is used that includes a scheduler module, a security module and a post-processing module.

The present invention discloses a method for performing network security functions using multiple security modules. The method includes operating a scheduler module, security module and post-processing module. The method includes the steps of receiving input data streams, processing the input data streams according to network security functions configured into the scheduler modules, security modules and post-processing modules, and outputting the results as output data streams.

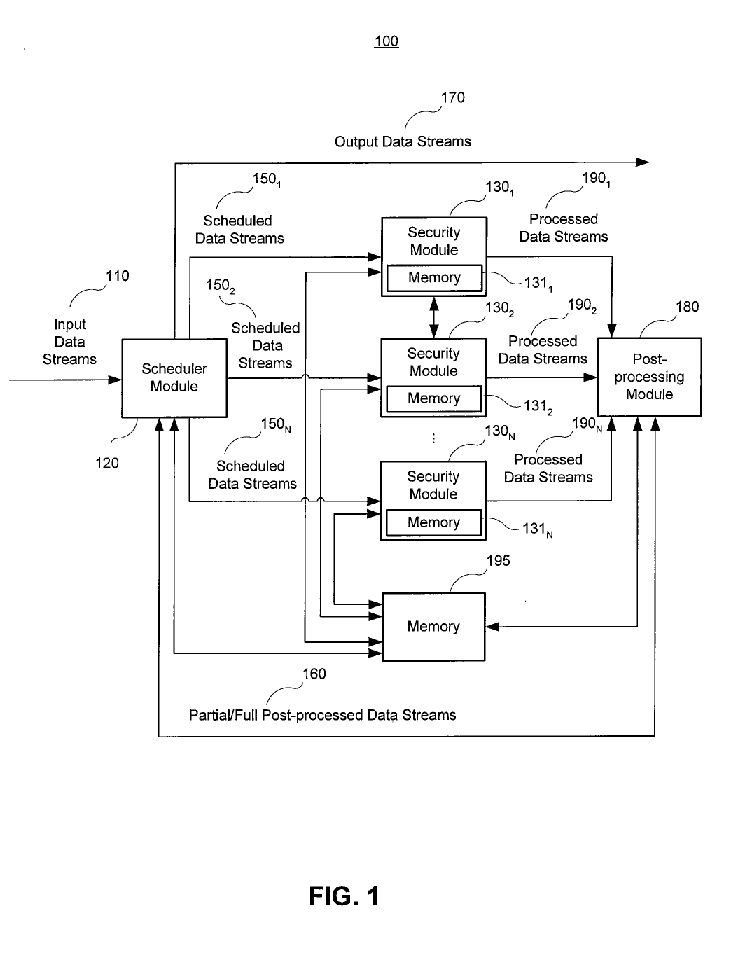

FIG. 1 shows various logic blocks of a multicore network security system 100, in accordance with one embodiment of the present invention. Shown, in part, in FIG. 1 are N security modules, where the first security module is labeled 130_{N}, second security module is labeled 130₂, and so on and so forth up to the N-th security module, which is labeled 130_{N} The N security modules are collectively and alternatively referred to as security modules 130. Each of the security modules 130 further includes a memory, where the memory of the first security module 130₁ is labeled 131₁, the memory of the second security module 130₂ is labeled 131₂, and so on and so forth up to the memory of the N-th security module 130_{N}, which is labeled 131_{N}. The memories of security modules 130 are collectively and alternatively referred to as memories 131. FIG. 1 also shows N scheduled data streams, where the first scheduled data stream is labeled 150₁, second scheduled data stream is labeled 150₂, and so on and so forth up to the N-th scheduled data stream, which is labeled 150_{N}. The N scheduled data streams are collectively referred to as scheduled data streams 150. FIG. 1 also shows N processed data streams, where the first processed data streams is labeled 190₁, second processed data streams is labeled 190₂, and so on and so forth up to the N-th processed data streams, which is labeled 190_{N}. The N processed data streams are collectively referred to as processed data streams 190.

In accordance with one embodiment of the present invention, scheduler module 120 is configured to perform scheduling of input data streams 110, as shown in FIG. 1. Scheduler module 120 is configured to route the input data streams 110 to security modules 130. Scheduled data streams 150₁ are routed to security module 130₁, scheduled data streams 150₂ are routed to security module 130₂, and scheduled data streams 150_{N} are routed to security module 130_{N}. Security modules 130 perform network security functions on the scheduled data streams 150 and output processed data streams 190 that are routed to a post-processing module 180. Security module 130₁ outputs processed data streams 190₁, security module 130₂ outputs processed data streams 190₂, and security module 130_{N} outputs processed data streams 190_{N}.

Post-processing module 180 receives the processed data streams 190 and processes them to form partial/full post-processed data streams 160 that are routed to scheduler module 120. Scheduler module 120 is further configured to process the received partial/full post-processed data streams 160. If further security processing is required, the partial/full post-processed data streams 160 are scheduled and routed to security modules 130 as scheduled data streams 150. If no further security processing is required, the scheduler module 120 generates output data streams 170.

Security modules 130 include one or more processing cores, where the processing cores are further configured to perform network security functions. The use of multiple processing cores and multiple security modules enable the simultaneous processing of multiple streams of input data. Network security functions often involve the processing of multiple independent streams of input data, and multiple elements within a group of input data. Memories 131 are utilized by security modules 130 during the operation of the security module. Security modules 130 are also coupled to a memory 195, which is also utilized during the operation of the security module. Memories 131 and 195 are used to store temporary or other data that result from the operation of the security modules. Post-processing module 180 and scheduler module 120 are also coupled to memory 195. Post-processing module 180 and scheduler module 120 store and retrieve data from memory 195. Memories 131 and 195 may operate in accordance with methods such as those disclosed in U.S. application Ser. Nos. 10/799,367, 10/850,978, and 10/850,979. Merely by way of example, memories 131 include:

Memories internal to an integrated circuit.

Independent memory modules.

Integrated circuits.

Internal registers in a CPU.

Internal registers in a GPU.

Content addressable memories (CAMs).

Ternary content addressable memories (TCAMs).

Cache memory.

Merely by way of example, memory 195 includes:

Memories internal to an integrated circuit.

Independent memory modules.

Integrated circuits.

Internal registers in a CPU.

Internal registers in a GPU.

Random access memory (RAM) coupled to the CPU.

Memories, such as texture memories, coupled to the GPU.

Content addressable memories (CAMs).

Ternary content addressable memories (TCAMs).

Cache memory.

Merely by way of example, security modules 130 may be configured to perform functions related to network security applications. Examples of network security applications include anti-virus, anti-spam, anti-spyware, intrusion detection, intrusion prevention, voice-over-IP, web-services-based, XML-based, network monitoring, network surveillance, content classification, copyright enforcement, policy and access control, and message classification systems. Examples of functions related to network security applications include pattern matching, data encryption, data decryption, data compression and data decompression. Furthermore, within those functions listed above may be more specific functions, such as pattern matching using table lookups, pattern matching using finite state machines, data encryption based on the triple-DES algorithm, and data compression using the LZW algorithm. Security modules 130 may be configured to perform any of the said functions. For example, a security module may be configured to perform functions related to a deterministic finite automaton (DFA), a non-deterministic finite automaton (NFA), a hybrid of DFA and NFAs, memory table lookups, hash functions, or the evaluations of functions.

Scheduler module 120 processes input data to produce scheduled data streams 150. Scheduler module 120 performs efficient scheduling of the scheduled data streams 150 for processing on the security modules 130, where efficient scheduling refers to the routing of scheduled data streams 150 onto security modules 130 that produces high overall processing throughput. Merely by way of example, efficient scheduling may be achieved by routing scheduled data streams 150 onto the least-utilized security module or processing core. Merely by way of example, efficient scheduling may be achieved by routing scheduled data streams 150 according to requirements and features specific to the network security functions used. Merely by way of example and with reference to FIG. 1, an e-mail received over the Internet is separated into its header and body parts. The header parts of the e-mail message are sent to security module 130₁, and the body parts of the e-mail message are then sent to security module 130₂. Since security module 130₁ operate concurrently with respect to security module 130₂, the header and body parts of the e-mail message are processed simultaneously. In another example and with reference to FIG. 1, each received e-mail is scheduled onto a security module selected from the group of security modules 130, where the selected security module has the least number of e-mails queued up for processing. In another example, an anti-virus application requiring pattern matching operations that use a first pattern database operates scheduler module 120 to schedule input data onto security module 130₁, where security module 130₁ provides pattern matching operations using the first pattern database. At the same time, an anti-spam application requiring pattern matching operations that use a second pattern database operates scheduler module 120 to schedule input data onto security module 130₂, where security module 130₂ provides pattern matching operations using the second pattern database. As security modules and processing cores operate in parallel, network security functions can be performed simultaneously on multiple elements derived from the input data, thus providing speed increases over traditional single security module or processing core systems.

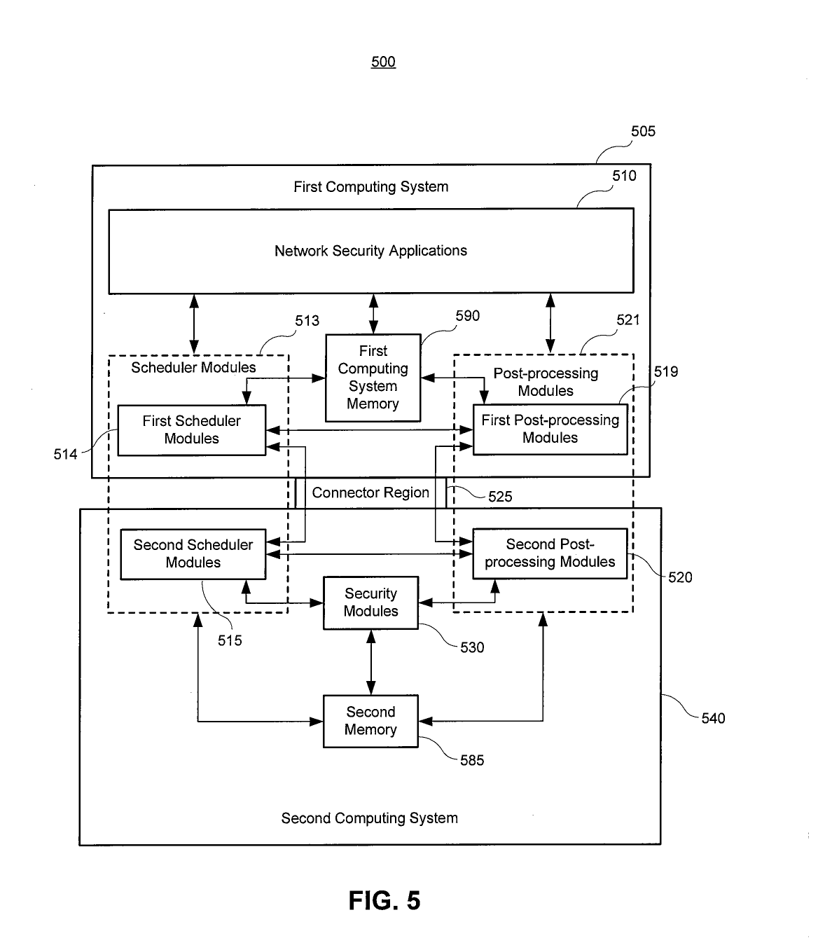

Network security functions often require multiple iterations over some common operation. Merely by way of example, a network security application, such as an anti-virus application, typically requires the repeated use of a pattern matching engine. This pattern matching engine may be provided by security modules 130, where the security modules 130, as well as scheduler module 120 and post-processing module 180, may be provided on a second computing system that is coupled to the anti-virus application via a connector region. FIG. 5 shows high level simplified block diagrams of a second computing system 540 coupled to a first computing system 505 via connector region 525, where network security applications 510 are operably coupled to the first computing system 505. In this example, network security applications 510 include the anti-virus application. Examples of a second computing system 540 include hardware circuitry designed to perform pattern matching at high speed. The following description of the continuing example refers to both FIGS. 1 and 5. Multiple iterations of the pattern matching engine can be performed by configuring post-processing module 180 to feed processed data back to scheduler module 120 when processed data is received from security modules 130. Post-processing module 180 then accumulates or post-processes the processed data received from security modules 130 before transmitting the aggregated results back to network security applications 510, which includes the anti-virus application in this example. Typically, data transfers between the second computing system 540 and the network security application 510 are slower than data transfers between modules residing completely on or in the second computing system 540. Therefore, the apparatus disclosed in the present invention may accelerate network security applications, such as the anti-virus application, by at least:
efficiently scheduling input data onto security modules or processing cores according to the requirements and features specific to network security functions;
processing multiple scheduled data stream simultaneously; and
operating a security module or processing core over multiple iterations.

Security modules 130 include one or more processing cores. In some embodiments, a processing core is an execution unit within a central processing unit (CPU), where the execution unit performs operations and calculations specified by instruction codes as a part of a computer program. In another embodiment, a processing core is a central processing unit (CPU). In another embodiment, a processing core is a processor within a multicore processor or CPU. Recent technological advances have resulted in the availability of multicore processors or CPUs that include two or more processors combined into a single package, such as a single integrated circuit or a single die. An example of a multicore CPU is the Intel® Pentium® D Processor, which contains two execution cores in one physical processor. Merely by way of example, each execution core of the Intel® Pentium® D Processor may be configured to perform network security functions. Another example of a CPU with multiple processing cores is the Dual-Core AMD Opteron™ Processor. In another embodiment of the present invention, a processing core is an execution unit within a processor within a multicore processor. In another embodiment, multiple CPUs are used to perform network security functions, where each CPU is configured to perform the functions of a processing core included in a security module.

In some embodiments, a processing core is a MIPS core provided within a processor, such as the Raza Microelectronics Inc. (RMI) XLR™ Family of Thread Processors and the Cavium Octeon™ MIPS64® Processors. Merely by way of example, one MIPS core may be dedicated to performing operating system (OS) functions, and other MIPS cores may be dedicated to performing network security functions. In another example, operating system (OS) functions and network security functions are context switched onto the multiple MIPS cores.

In some embodiments, a processing core is an execution unit within a graphical processing unit (GPU), where the execution units include fragment and vertex processors. GPUs are normally provided on a video card unit that is coupled to a computing system. The video card provides accelerated graphics functionalities to the computing system. However, instead of the video card form factor, GPUs may be provided on other special purpose built form factors and circuit boards. Advances in GPU technology have resulted in greater programmability of the fragment and vertex processors. In line with the advances in GPU technology, there has been increasing research into the use of GPUs for general non-graphics related computations. In one embodiment of the present invention, the processors within a GPU are programmed to perform network security functions. Merely by way of example, the GPU may be configured to perform the functions of a security module, and the fragment and vertex processors in the GPU may be configured to perform the functions of processing cores. In another embodiment, multiple GPUs can be used, where each GPU performs the functions of a security module. Merely by way of example, two nVidia® GeForce® 7800GTX video cards may be coupled to a computing system via PCI-Express interfaces, and each video card may be configured to perform network security functions. In another embodiment, two video cards may be coupled to a computing system, and one video card is configured to perform network security functions, and the other video card is configured to perform normal video functions. In another embodiment, two or more cards can operate simultaneously to perform network security functions. Merely by way of example, through technologies such as Scalable Link Interface (SLI) from nVidia Corporation, two or more cards can operate simultaneously to perform network security functions. In this configuration, each GPU on each video card performs the functions of a security module. This example can also be applied to GPU products from ATI Technologies Inc., where one ATI Radeon® X1900 Series video card and one ATI Radeon® X1900 CrossFire™ Edition video card are coupled to a computing system via PCI-Express interfaces, and each video card is configured to perform network security functions by appropriately programming the processors provided by the two GPUs. Each GPU on each video card may be configured and programmed to perform the functions of a security module. In another example, the GPU on one video card performs the functions of a security module, and the GPU on a second video card performs video functions.

Merely by way of example, a GPU is configured to perform the network security functions of Base64 encoding/decoding, Uuencode, Uudecode, Quoted-Printable, BinHex, encryption, decryption, and MD5 hashing. In one embodiment, a GPU is configured to operate a DFA by implementing methods such as those disclosed in U.S. application Ser. Nos. 10/850,978 and 10/850,979, operate an NFA by implementing methods similar to those disclosed in U.S. application Ser. Nos. 10/850,978 and 10/850,979, or a hybrid of a DFA and NFA. The DFAs and NFAs may be used to match patterns on input data. The multiple vertex and fragment processors correspond to processing cores, and in one embodiment, the parallelism offered by these processing cores enable multiple streams of input data to be processed simultaneously. In another embodiment, the parallelism offered by these processing cores enable multiple data to be processed simultaneously, where the multiple data is derived from input data. In one embodiment, an application programming interface (API) is used to program a GPU to perform any of the functions of a scheduler module, security module and/or post-processing module. Merely by way of example, APIs that may be used to program a GPU include Cg, HLSL, Brook, and Sh. In one embodiment, assembly code is written to operate a GPU.

In some embodiments, a processing core is an execution unit within a physics processing unit (PPU). PPUs are typically included on a PCI card form factor, but may also come in other form factors, such as being integrated into the motherboard of a computer system. The main processing unit of the PPU is typically provided in an integrated circuit. The PPU is typically used for performing complex physics calculations. The execution units of the PPU may be adapted to perform some or all of the functions disclosed in this invention. Merely by way of example, a PPU may be the PhysX PPU by Ageia.

In some embodiments, security modules 130 include dedicated network security hardware devices comprising one or more processing cores. In another embodiment, security modules 130 are a processing core of a dedicated network security hardware device.

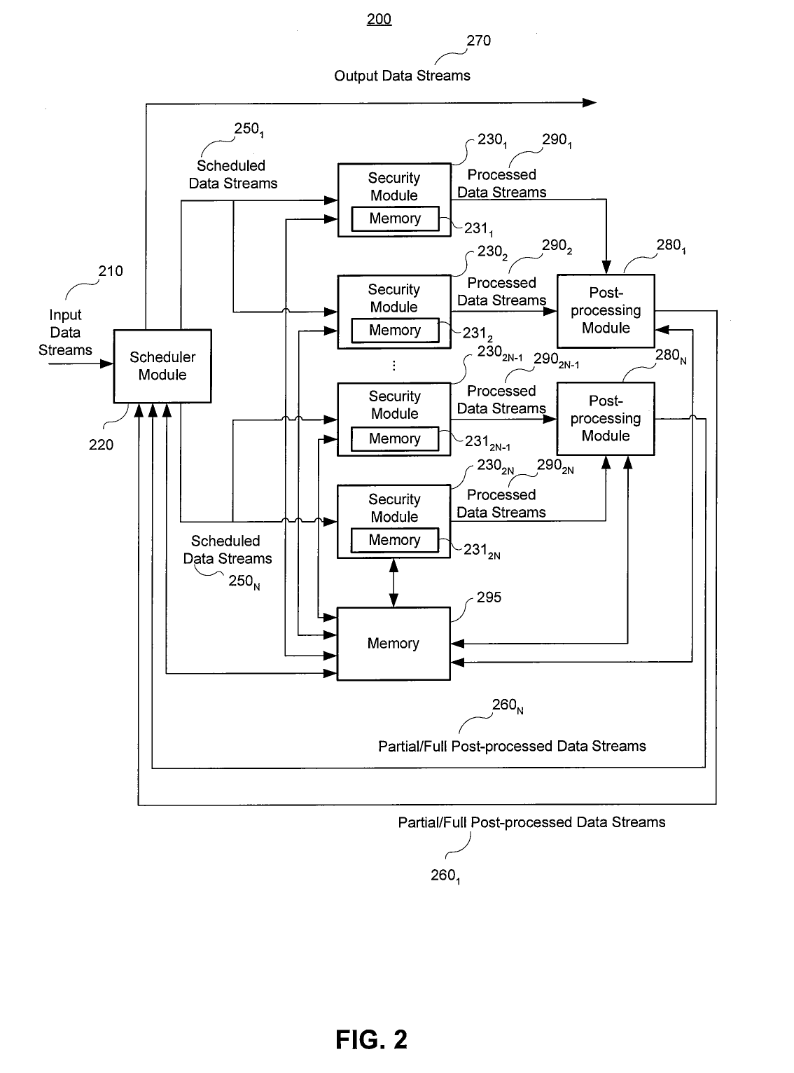

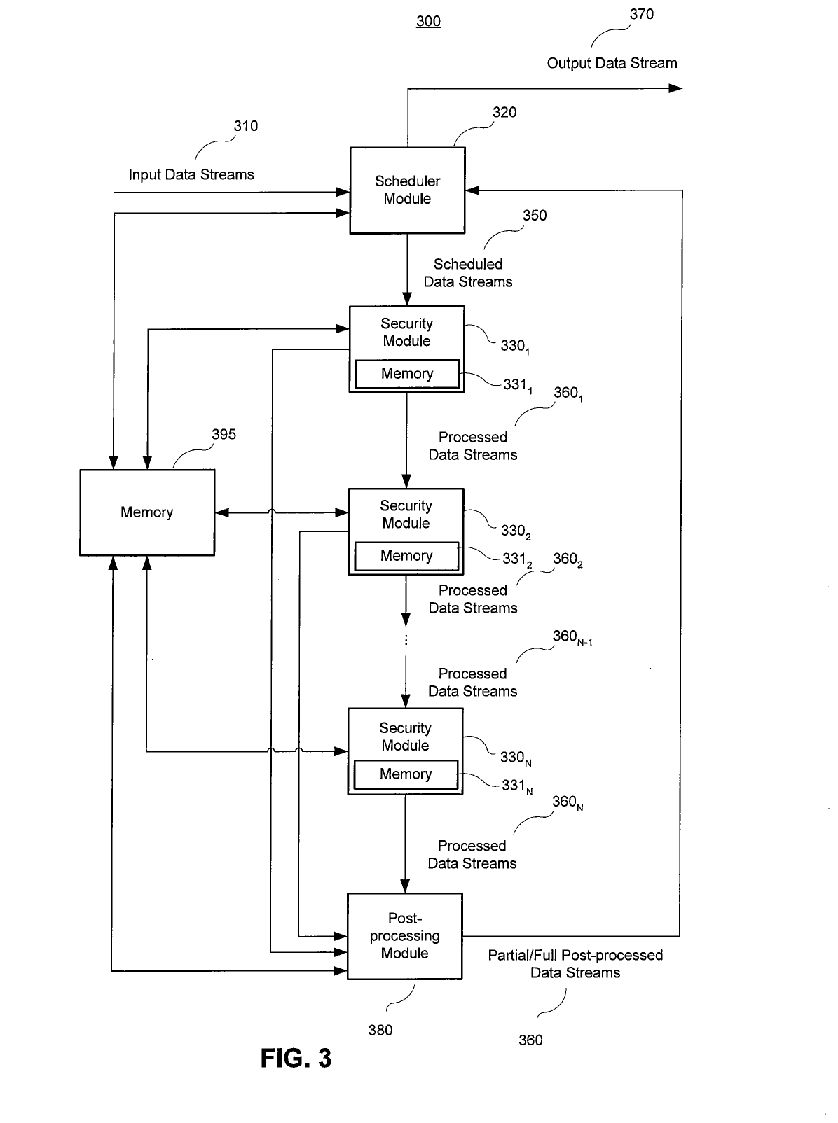

FIG. 2 shows various logic blocks of a multicore network security system 200, in accordance with another embodiment of the present invention. Shown, in part, in FIG. 3 are 2N security modules, where the first security module is labeled 230₁, second security module is labeled 230₂, and so on and so forth up to the 2N-th security module, which is labeled 230_{2N}. The 2N security modules are collectively referred to as security modules 230. Each of the security modules 230 further include a memory, where the memory of the first security module 230₁ is labeled 231₁, the memory of the second security module 230₂ is labeled 231₂, and so on and so forth up to the memory of the 2N-th security module 230_{2N}, which is labeled 231_{2N}. The memories of security modules 230 are collectively referred to as memories 231. FIG. 2 also shows N scheduled data streams, where the first scheduled data stream is labeled 250₁, and so on and so forth up to the N-th scheduled data stream, which is labeled 250_{N}. The N scheduled data streams are collectively referred to as scheduled data streams 250. FIG. 2 also shows 2N processed data streams, where the first processed data streams is labeled 290₁, second processed data streams is labeled 290₂, and so on and so forth up to the 2N-th processed data streams, which is labeled 290_{2N}. The 2N processed data streams are collectively referred to as processed data streams 290. FIG. 2 also shows N post-processing modules, where the first post-processing module is labeled 280₁, and so on and so forth up to the N-th post-processing module, which is labeled 280_{N}. The N post-processing modules are collectively referred to as post-processing modules 280. FIG. 2 also shows N partial/full post-processed data streams, where the first partial/full post-processed data streams is labeled 260₁, and so on and so forth up to the N-th partial/full post-processed data streams, which is labeled 260_{N}. The N partial/full post-processed data streams are collectively referred to as partial/full post-processed data streams 260.

In accordance with one embodiment of the present invention, scheduler module 220 is configured to perform scheduling of the input data streams 210, as shown in FIG. 2. This embodiment has the scheduler module being configured to route one scheduled data stream to more than one security module. Scheduler module 220 is configured to route scheduled data streams 250 onto security modules 230. Merely by way of example, scheduled data streams 250₁ are routed to both security module 230₁ and security module 230₂. Scheduled data streams 250_{N} are routed to both security module 230_{2N-1} and security module 230_{2N}. In other respects, scheduler module 220 operate in a similar manner to scheduler module 120 of FIG. 1. Scheduled data streams 250 have the same characteristics as scheduled data streams 150 that are shown in FIG. 1. Security modules 230 perform the same functions as security modules 130 that are shown in FIG. 1.

Security modules 230 perform network security functions on scheduled data streams 250 and output processed data streams 290 that are routed to post-processing modules 280. The outputs of security module 230₁ and security module 230₂ are routed to post-processing module 280₁. The outputs of security module 230_{2N-1} and security module 230_{2N} are routed to post-processing module 280_{N}. Memories 231 are utilized by security modules 230 during the operation of the security module. Security modules 230 are also coupled to memory 295, which is also utilized during the operation of the security module. Memories 231 and 295 are used to store temporary or other data that result from the operation of the security modules. Post-processing module 280 and scheduler module 220 are also coupled to memory 295. Post-processing module 280 and scheduler module 220 store and retrieve data from memory 295. Memories 231 and 295 may operate in accordance with methods such as those disclosed in U.S. application Ser. Nos. 10/799,367, 10/850,978, and 10/850,979. Memories 231 operate in a similar manner to memories 131, and memory 295 operate in a similar manner to memory 195.

Post-processing modules 280 receive the processed data streams 290 and process them to form partial/full post-processed data streams 260 that are routed to the scheduler module 220. Post-processing module 280₁ generates partial/full post-processed data streams 260₁, and post-processing module 280_{N} generates partial/full post-processed data streams 260_{N}. Scheduler module 220 is further configured to process the received partial/full post-processed data streams 260. If further security processing is required, then the relevant data streams in the partial/full post-processed data streams 260 are scheduled and routed to security modules 230 as scheduled data streams 250. If no further security processing is required on a data stream of the partial/full post-processed data streams 260 because that data stream has been fully processed, then the scheduler module 220 generates output data streams 270. In other respects, post-processing modules 280 operate in a manner similar to post-processing module 180 of FIG. 1.

FIG. 3 shows various logic blocks of a multicore network security system 300, in accordance with another embodiment of the present invention. Shown, in part, in FIG. 3 are shows N security modules, where the first security module is labeled 330₁, second security module is labeled 330₂, and so on and so forth up to the N-th security module, which is labeled 330_{N}. The N security modules are collectively referred to as security modules 330. Each of the security modules 330 further include a memory, where the memory of the first security module 330₁ is labeled 331₁, the memory of the second security module 330₂ is labeled 331₂, and so on and so forth up to the memory of the 2N-th security module 330_{2N}, which is labeled 331_{2N}. The memories of security modules 330 are collectively referred to as memories 331. FIG. 3 also shows N processed data streams, where the first processed data streams is labeled 360₁, second processed data streams is labeled 360₂, and so on and so forth up to the N-th processed data streams, which is labeled 360_{N}. The N processed data streams are collectively referred to as processed data streams 360.

In accordance with one embodiment of the present invention, a scheduler module 320 is configured to perform scheduling of the input data streams 310, as shown in FIG. 3. Security modules 330 perform the same functions as security modules 130 that are shown in FIG. 1. Scheduled data streams 350 have the same characteristics as scheduled data streams 150 that are shown in FIG. 1. This embodiment has security modules 330 coupled in a chained arrangement. Scheduler module 320 is configured to schedule the data streams to be routed to first security module 330₁. In other respects, scheduler module 320 operates in a manner similar to scheduler module 120 of FIG. 1. Security modules 330₁ perform network security functions on scheduled data streams 350 and output processed data streams 360₁. Processed data streams 360₁ are routed to security module 330₂ or to post-processing module 380. The output of security module 330₂ is routed to either post-processing module 380 or to the following security module as processed data streams 360₂. Security module 330_{N} receives processed data stream 360_{N-1} and generates and outputs the processed data streams 360_{N}. Processed data streams 360_{N} is routed to post-processing module 380. Memories 331 are utilized by security modules 330 during the operation of the security module. Security modules 330 are also coupled to memory 395, which is also utilized during the operation of the security module. Memories 331 and 395 are used to store temporary or other data that result from the operation of the security modules. Post-processing module 380 and scheduler module 320 are also coupled to memory 395. Post-processing module 380 and scheduler module 320 store and retrieve data from memory 395. Memories 331 and memory 395 may operate in accordance with methods such as those disclosed in U.S. application Ser. Nos. 10/799,367, 10/850,978, and 10/850,979. Memories 331 operate in a similar manner to memories 131, and memory 395 operate in a similar manner to memory 195.

Post-processing module 380 receives the processed data streams and processes them to form partial/full post-processed data streams 360 that are routed to the scheduler module 320. Scheduler module 320 is further configured to process the received partial/full post-processed data streams 360. If further security processing is required, the partial/full post-processed data streams 360 are scheduled and routed to security module 330₁ as scheduled data streams 350. If no further security processing is required, the scheduler module 320 generates output data stream 370. The ordering of security modules is fixed only for a single pass of data and on second and successive passes of data from the scheduler module 320 to the post-processing module 380, the ordering of security modules may change. For example, data can be routed from scheduler module 320 to security module 330₁ to post-processing module 380 to scheduler module 320 and then to security module 330₂. In one embodiment, the functionality of security modules changes between passes. In other respects, post-processing module 380 operates in a manner similar to post-processing module 180 of FIG. 1.

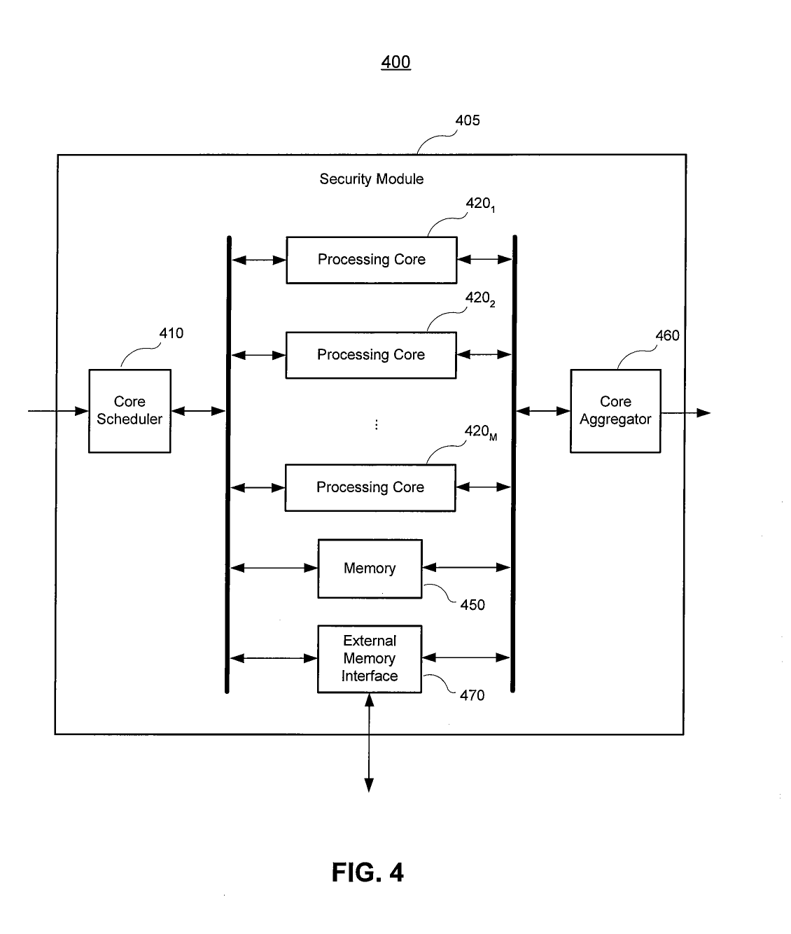

FIG. 4 shows a detailed view of a security module 405 referred to as security modules 130, 230 and 330 respectively in FIGS. 1, 2 and 3, in accordance with one exemplary embodiment of the present invention. Concurrent references to FIGS. 1 and 4 are made below. Embodiment 400 of the security module is shown as including core scheduler 410, memory 450, core aggregator 460 and external memory interface 470. FIG. 4 also shows M processing cores, where the first processing core is labeled 420₁, second processing core is labeled 420₂, and so on and so forth up to the M-th processing core, which is labeled 420_{M}. The M processing cores are collectively referred to as processing cores 420. Core scheduler 410 receives and processes scheduled data streams 150 to partition the data for simultaneous processing on processing cores 420. Processing cores 420 process the received data, possibly using extra data read from memory 450 and/or data read via external memory interface 470. Processing cores 420 store data in memory 450 and/or to a location via external memory interface 470. Core aggregator 460 receives results from processing cores 420 and processes the results to form processed data streams 190 that are outputted from security module 405. In producing processed data streams 190, core aggregator 460 retrieves data from and/or store data to memory 450. Memory 450 operates in a manner similar to one of the memories 131 of FIG. 1. In producing processed data streams 190, core aggregator 460 retrieves data from and/or store data to a location accessed via external memory interface 470. External memory interface 470 may be coupled to a memory, such as memory 195.

In accordance with one embodiment of the present invention, FIG. 5 shows security modules 530 provided on second computing system 540, where the second computing system 540 is coupled to first computing system 505. The coupling is assisted by connector region 525. Merely by way of example, connector region 525 includes a PCI, PCI-X, PCI Express, USB, memory bus, FireWire, wireless, network, custom data bus, or general data bus, memory bus interface, etc. With reference to FIGS. 1, 2 and 3, security modules 530 may be security modules 130, 230 or 330. Also with reference to FIGS. 1, 2 and 3, scheduler modules 513 may be scheduler module 120, 220 or 320, and post-processing modules 521 may be post-processing module 180, 280 or 380. Network security applications 510 are operably connected to first computing system 505. Examples of network security applications 510 include anti-spam, anti-virus, anti-spyware, intrusion detection, intrusion prevention, content filtering, content security, XML-based parsing and filtering applications. Other examples of network security applications 510 include any application implementing any of the network security functions described herein. Scheduler modules 513 and post-processing modules 521 are coupled in part to the first computing system 505 and second computing system 540. In this manner, elements of scheduler modules 513 are distributed between first computing system 505 and second computing system 540. Elements of scheduler modules 513 provided by first computing system 505 are also referred to as first scheduler modules 514 and elements of scheduler modules 513 provided by second computing system 540 are also referred to as second scheduler modules 515. Similarly, elements of post-processing modules 521 are distributed between first computing system 505 and second computing system 540. Elements of post-processing modules 521 provided by first computing system 505 are also referred to as first post-processing modules 519 and elements of post-processing modules 521 provided by second computing system 540 are also referred to as second post-processing modules 520. Security modules 530 are provided by second computing system 540. Merely by way of example, second computing system 540 includes a module that controls the flow of data between the first computing system and the second computing system. An example of such a module is a direct memory access (DMA) controller. Other examples of modules that may be provided by second computing system 640 include hardware logic, processing modules configured to execute programs using a central processing unit (CPU), processing modules configured to execute programs using a graphics processing unit (GPU), or other integrated circuits. Merely by way of example and with reference to FIG. 1, security modules 130, scheduler modules 120 and post-processing modules 180 may be provided by second computing system 540 that includes at least a multicore processing unit and memory modules.

Merely by way of example, second computing system 540 may include a processing circuit board that includes a field programmable gate array (FPGA) configured to perform any of the functions of a second computing system described above. The processing circuit board may couple to a first computing system via an interface, such as the PCI, PCI-X, PCI Express bus interface. Other examples of a second computing system include a video card comprising a GPU, a gaming console, such as the Microsoft® box and Sony® PlayStation® gaming consoles, field programmable gate array (FPGA), application specific integrated circuit (ASIC), custom integrated circuit, or other integrated circuits.

FIG. 5 also shows first computing system memory 590 coupled to first scheduler modules 514 and first post-processing modules 519. First computing system memory 590 is used to store data prior to, during, or after processing by scheduler modules 513, security modules 530 or post-processing modules 521. Memory 585 is coupled to scheduler modules 513, security modules 530, and post-processing modules 521. Memory 585 operates in a manner similar to memory 195 of FIG. 1.

In one embodiment, the computing functions of the first computing system 505 and second computing system 540 are provided by at least one processor with multiple cores. The functions of the first computing system 505 and second computing system 540 are provided on cores that are dedicated to each system, or the functions may be context switched onto the multiple cores.

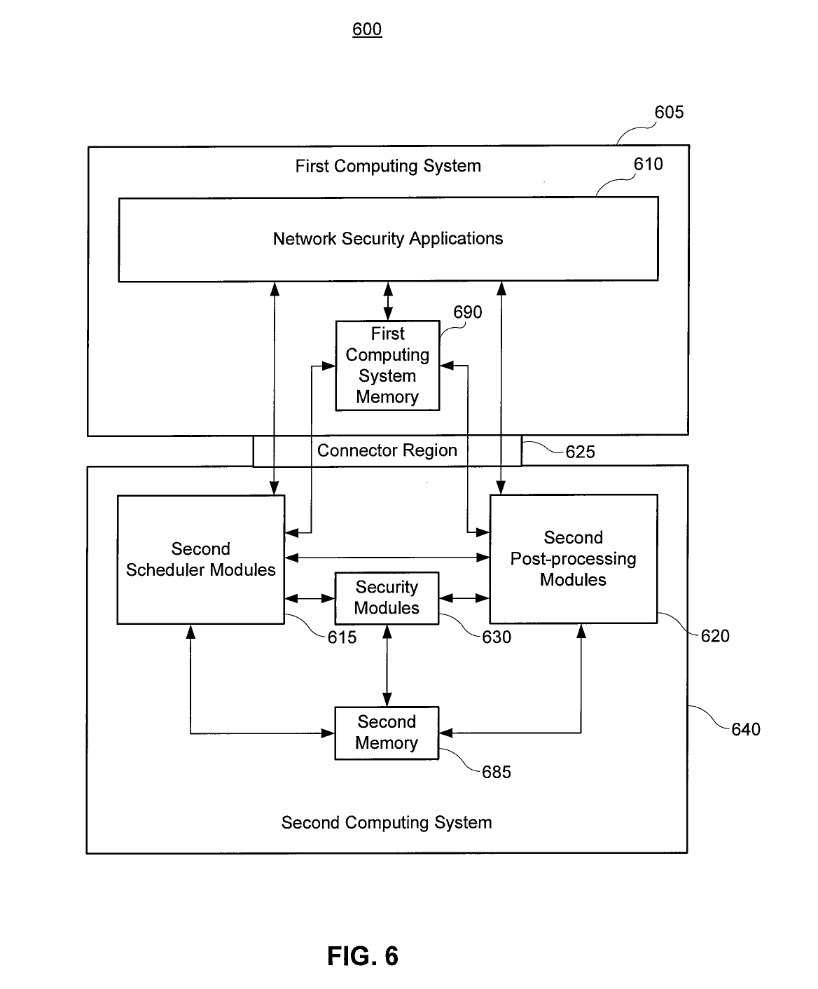

In accordance with another embodiment of the present invention, FIG. 6 shows security modules 630 provided on second computing system 640, where the second computing system 640 is coupled to the first computing system 605. The coupling is assisted by connector region 625 in a similar manner to connector region 525 of FIG. 5. With reference to FIGS. 1, 2 and 3, security modules 630 may be security modules 130, 230 or 330. Also with reference to FIGS. 1, 2 and 3, second scheduler modules 615 may be scheduler module 120, 220 or 320, and second post-processing modules 620 may be post-processing module 180, 280 or 380. Security modules 630 are wholly provided by second computing system 640. Network security applications 610 execute on first computing system 605, where network security applications 610 operate in a manner similar to network security applications 510 of FIG. 5. First computing system 605 is coupled to second computing system 640 via connector region 625. Second computing system 640 may also include modules such as those described for second computing system 540.

FIG. 6 also shows first computing system memory 690 coupled to second scheduler modules 615 and second post-processing modules 620. In a similar manner to first computing system memory 590 of FIG. 5, first computing system memory 690 is used to store data prior to, during, or after processing by second scheduler modules 615, security modules 630 or second post-processing modules 620. Memory 685 is coupled to second scheduler modules 615, security modules 630, and second post-processing modules 620. Memory 685 operates in a manner similar to memory 195 of FIG. 1.

In one embodiment, the computing functions of the first computing system 605 and second computing system 640 are provided by at least one processor with multiple cores. The functions of the first computing system 605 and second computing system 640 are provided on cores that are dedicated to each system, or the functions may be context switched onto the multiple cores.

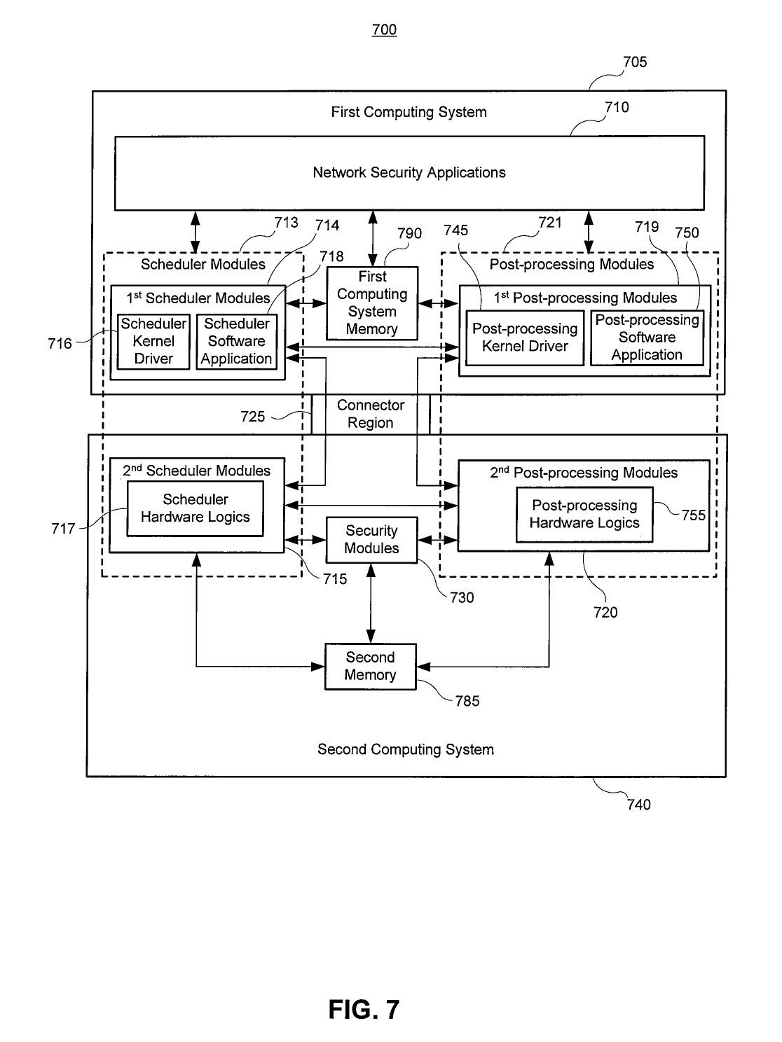

In accordance with another embodiment of the present invention, FIG. 7 shows security modules 730 provided on second computing system 740, where the second computing system 740 is coupled to the first computing system 705. The coupling is assisted by connector region 725 in a similar manner to connector region 525 of FIG. 5. With reference to FIGS. 1, 2 and 3, security modules 730 may be security modules 130, 230 or 330. Also with reference to FIGS. 1, 2 and 3, scheduler modules 713 may be scheduler module 120, 220 or 320, and post-processing modules 721 may be post-processing module 180, 280 or 380. Scheduler modules 713 include scheduler kernel driver 716 and scheduler hardware logics 717. Scheduler modules 713 are provided in part by first computing system 705 and by second computing system 740. In one embodiment, scheduler modules 713 include in part first scheduler modules 714 and second scheduler modules 715. First scheduler modules 714 are provided by first computing system 705 and second scheduler modules 715 are provided by second computing system 740, where second computing system 740 is coupled to first computing system 705. Scheduler kernel driver 716, provided by first scheduler modules 714, is executed on first computing system 705. Scheduler hardware logics 717, provided by second scheduler modules 715, are executed on second computing system 740. Scheduler kernel driver 716 performs the steps of receiving input data streams from network security applications 710, processing the input data streams and selectively scheduling the input data streams onto one or more scheduled data streams. Scheduler kernel driver 716 communicates data and control signals to and from scheduler hardware logics 717 to deliver the one or more scheduled data streams to security modules 730 provided on second computing system 740. In one embodiment, scheduler hardware logics 717 perform the steps of communicating commands to and from first computing system 705, receiving one or more scheduled data streams and transmitting the one or more scheduled data streams to security modules 730. Security modules 730 perform processing on the scheduled data streams.

Scheduler modules 713 include in part scheduler software application 718 and scheduler hardware logics 717. Scheduler modules 713 are provided in part by first computing system 705 and by second computing system 740. Scheduler modules 713 include in part first scheduler modules 714 and second scheduler modules 715. First scheduler modules 714 are provided by first computing system 705 and second scheduler modules 715 are provided by second computing system 740, where second computing system 740 is coupled to first computing system 705. Scheduler software applications 718, provided by first scheduler modules 714, are executed on first computing system 705. Scheduler hardware logics 717, provided by second scheduler modules 715, are executed on second computing system 740. Scheduler software application 718 perform the steps of receiving input data streams from network security applications 710, processing the input data streams and selectively scheduling the input data streams onto one or more scheduled data streams. Network security applications 710 operate in a manner similar to network security applications 510 of FIG. 5. Scheduler software application 718 communicate data and control signals to and from scheduler hardware logics 717 to deliver the one or more scheduled data streams to security modules 730 provided on second computing system 740. In one embodiment, scheduler hardware logics 717 perform the steps of communicating commands to and from first computing system 705, receiving one or more scheduled data streams and transmitting the one or more schedule data streams to security modules 730. Security modules 730 perform processing on the scheduled data streams.

FIG. 7 also shows first computing system memory 790 coupled to first scheduler modules 714, first post-processing modules 719, and network security applications 710. In a manner similar to first computing system memory 590 of FIG. 5, first computing system memory 790 is used to store data prior to, during, or after processing by scheduler modules 713, security modules 730 or post-processing modules 721. Memory 785 is coupled to scheduler modules 713, security modules 730, and post-processing modules 721. Memory 785 operates in a manner similar to memory 195 of FIG. 1.

In one embodiment, the computing functions of the first computing system 705 and second computing system 740 are provided by at least one processor with multiple cores. The functions of the first computing system 705 and second computing system 740 may be provided on cores that are dedicated to each system, or the functions may be context switched onto the multiple cores.

In one embodiment, scheduler hardware logics 717 are provided by at least a GPU on a video card, or other processing modules on the video card. Merely by way of example, the GPU directs one or more scheduled data streams to one or more vertex and fragment processors. In another embodiment, scheduler hardware logics 717 are provided by at least the hardware logic in a field programmable gate array (FPGA). For example, logic in an FPGA directs the one or more scheduled data streams to processing cores within the same FPGA, or to other processing modules.

FIG. 7 shows post-processing modules 721 comprising post-processing kernel driver 745 and post-processing hardware logics 755. Post-processing modules 721 are provided in part by first computing system 705 and by second computing system 740. Post-processing modules 721 include in part first post-processing modules 719 and second post-processing modules 720. First post-processing modules 719 are provided by first computing system 705 and second post-processing modules 720 are provided by second computing system 740, where second computing system 740 is coupled to first computing system 705. Post-processing kernel driver 745, provided by first post-processing modules 719, is executed on first computing system 705. Post-processing hardware logics 755, provided by second post-processing modules 720, are executed on second computing system 740. Post-processing hardware logics 755 perform the steps of receiving processed data streams from security modules 730, partially processing the processed data streams to form partially post-processed data streams, and transmitting the partially post-processed data streams to post-processing kernel driver 745. Post-processing kernel driver 745 communicate data and control signals to and from post-processing hardware logics 755 to perform the steps of receiving partially post-processed data streams and processing the partially post-processed data streams to generate fully post-processed data streams, and transmitting the fully post-processed data streams to first scheduler modules 714. In one embodiment, the partially or fully post-processed data streams are transmitted to network security applications 710. A post-processed data stream may be a partially or fully post-processed data stream.

FIG. 7 shows post-processing modules 721 comprising post-processing software application 750 and post-processing hardware logics 755. Post-processing modules 721 are provided in part by first computing system 705 and by second computing system 740. Post-processing modules 721 include in part first post-processing modules 719 and second post-processing modules 720. First post-processing modules 719 are provided by first computing system 705 and second post-processing modules 720 are provided by second computing system 740, where second computing system 740 is coupled to first computing system 705. Post-processing software application 750, provided by first post-processing modules 719, are executed on first computing system 705. Post-processing hardware logics 755, provided by second post-processing modules 720, are executed on second computing system 740. Post-processing hardware logics 755 perform the steps of receiving processed data streams from security modules 730, partially processing the processed data streams to form partially post-processed data streams, and transmitting the partially post-processed data streams to post-processing software application 750. Post-processing software application 750 communicates data and control signals to and from post-processing hardware logics 755 to perform the steps of receiving partially post-processed data streams and processing the partially post-processed data streams to generate fully post-processed data streams, and transmitting the fully post-processed data streams to first scheduler modules 714. In one embodiment, the partially or fully post-processed data streams are transmitted to network security applications 710. A post-processed data stream may be a partially or fully post-processed data stream, such as partial/full post-processed data streams 160, 260, or 360 (shown in FIGS. 1, 2 and 3).

In one embodiment, post-processing hardware logics 755, being provided by second post-processing modules 720, transmits partially or fully post-processed data streams to scheduler hardware logics 717, which are provided by second scheduler modules 715. Both, post-processing hardware logics 755 and scheduler hardware logics 717 are provided on the same second computing system. Any of the post-processing kernel driver, scheduler kernel driver, post-processing software application, and scheduler software application may be provided on one or more first computing systems.

In one embodiment, post-processing hardware logics 755 are provided by at least a GPU on a video card, or other processing modules on the video card. For example, the post-processing hardware logic in a GPU directs processing results from vertex and fragment processors to texture memory. The same processing results are then be used on the next processing iteration of the vertex and fragment processors. Alternatively, the processing results are transmitted to a post-processing kernel driver or post-processing software application for further post-processing of network security functions.

In another embodiments, scheduler hardware logics 717, post-processing hardware logics 755, and security modules 730 are provided by processing platforms such as a central processing unit (CPU), graphics processing unit (GPU), a gaming console, such as the Microsoft® Xbox and Sony® PlayStation® gaming consoles, field programmable gate array (FPGA), application specific integrated circuit (ASIC), custom integrated circuit, or other integrated circuits. In one embodiment, one or more of the processing platforms are operated concurrently, where the processing platforms are coupled to a first computing system 705.

In one embodiment, post-processing modules 721 are wholly provided by a post-processing kernel driver, post-processing software application, one or more post-processing hardware logics, or other integrated circuits.

In one embodiment, scheduler modules 713 schedule the input data streams onto the one or more scheduled data streams in a random manner. In another embodiment, scheduler modules 713 schedule the input data streams onto the one or more scheduled data streams in a round-robin fashion. In still another embodiment, scheduler modules 713 are wholly provided by a scheduler kernel driver, scheduler software application, one or more scheduler hardware logics, or other integrated circuits.

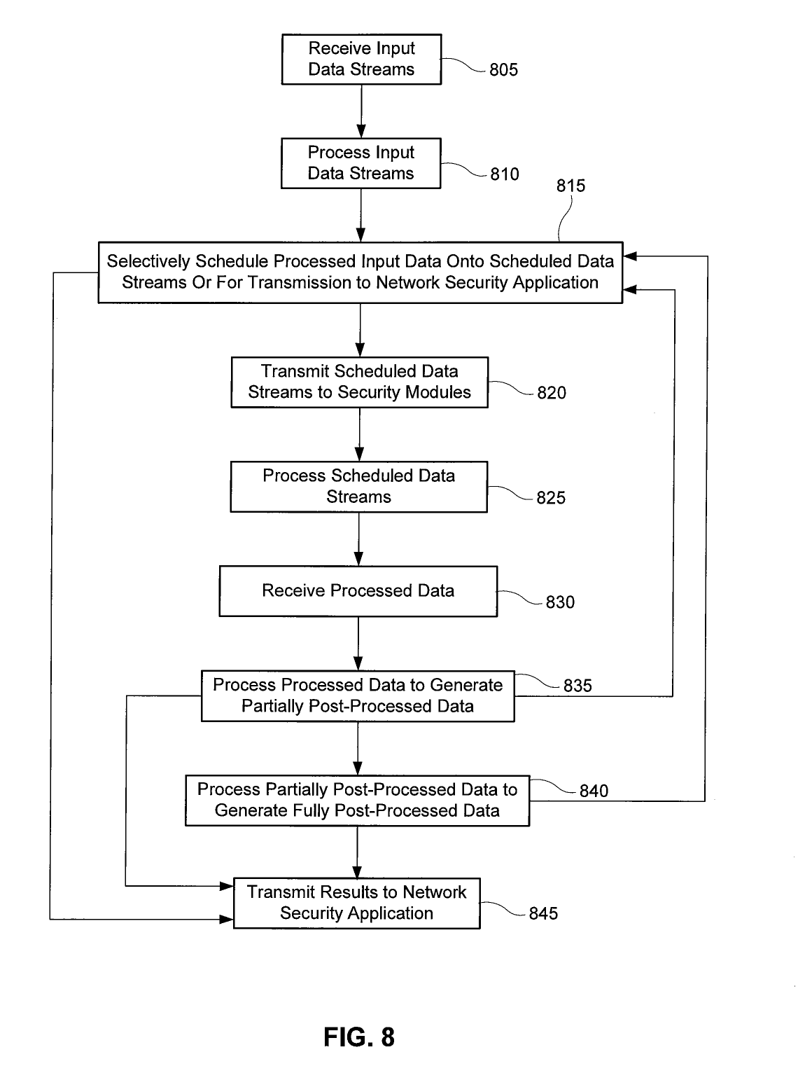

FIG. 8 illustrates a flowchart of the process of operating a high performance network security system. Step 805 involves performing the step of receiving input data streams from network security application, such as network security applications 710 as shown in FIG. 7. The input data streams are processed in step 810, and selective scheduling of input data streams onto one or more scheduled data streams occurs in step 815. In step 820, scheduled data streams are transmitted to security modules. Merely by way of example, step 820 includes a scheduler kernel driver, such as scheduler kernel driver 716 of FIG. 7, communicating data and control signals to and from scheduler hardware logics 717 (of FIG. 7) to deliver the one or more scheduled data streams to security modules 730 (of FIG. 7) provided on second computing system 740 (of FIG. 7). In step 825, scheduled data streams are processed to form processed data streams, where the processing involves performing network security functions. Step 830 includes receiving the processed data streams, and step 835 involves partially processing the processed data streams to form partially post-processed data streams. The partially post-processed data streams are then be selectively scheduled for further processing as in step 815, transmitted to network security application in step 845 (see below), or further processed in step 840. Step 840 involves receiving partially post-processed data streams and processing the partially post-processed data streams to generate fully post-processed data streams. The fully post-processed data streams are then selectively scheduled for further processing as in step 815, or transmitted to network security application in step 845. In step 845, the partially or fully post-processed data streams are then transmitted to network security application, such as network security applications 710 (of FIG. 7).

In one embodiment, a GPU is configured to include security modules that perform pattern matching, where the security modules may be security modules 130 of FIG. 1. The GPU is also configured to perform post-processing. In this embodiment, the post-processing performed by the GPU includes aggregating pattern matches and match events. These pattern matches and match events are returned to the first computing system at regular or irregular intervals.

In one embodiment, a CPU is configured to include security modules that perform pattern matching, where the security modules may be security modules 130 of FIG. 1. The CPU is also configured to perform post-processing. In this embodiment, the post-processing performed by the CPU includes aggregating pattern matches and match events. These pattern matches and match events may be returned to the first computing system at regular or irregular intervals.

In one embodiment, hardware logics, such as those provided in a field programmable gate array (FPGA) or application specific integrated circuit (ASIC), are configured to include security modules that perform pattern matching, where the security modules may be security modules 130 of FIG. 1. The hardware logics are also configured to perform post-processing, where the post-processing performed by the hardware logics may include aggregating pattern matches and match events. These pattern matches and match events may be returned to the first computing system at regular or irregular intervals.

Although the foregoing invention has been described in some detail for purposes of clarity and understanding, those skilled in the art will appreciate that various adaptations and modifications of the just-described preferred embodiments can be configured without departing from the scope and spirit of the invention. For example, different security module topologies may be present. Moreover, the described data flow of this invention may be implemented within separate security systems, or in a single security system, and running either as separate applications or as a single application. Therefore, the described embodiments should not be limited to the details given herein, but should be defined by the following claims and their full scope of equivalents.

What is claimed is:

1. A multicore network security system configured to perform network security functions, the system comprising:
a first computing system configured to operate a network security application; and
a second computing system coupled to the first computing system and comprising:
at least one scheduler module configured to receive data streams from the first computing system and to generate one or more scheduled data streams and one or more output data streams in response;
at least one security module configured to receive the one or more scheduled data streams and to generate one or more processed data streams in response; and
at least one post-processing module configured to post-process the one or more processed data streams to generate and output post-processed data streams.

2. The system of claim 1 wherein said first computing system further comprises:
at least one scheduler module configured to communicate data and control signals to and from the at least one scheduler module of the second computing system, the at least one scheduler module of the first computing system further configured to receive one or more input data streams from the network security application and to operate with the at least one scheduler module of the second computing system to generate the one or more scheduled data streams and the one or more output data streams in response; and
at least one post-processing module configured to operate to communicate data and control signals to and from the at least one post-processing module of the second computing system, the at least one post-processing modules of the first computing system configured to post-process the one or more processed data streams to generate and output post-processed data streams.

3. The system of claim 1 wherein said at least one security module of the first computing system further comprise a first memory.

4. The system of claim 1 wherein said second computing system further comprise a second memory.

5. The system of claim 1 wherein said first computing system further comprise a memory in communication with the at least one scheduler module of the second computing system and the at least one post-processing module of the second computing system.

6. The system of claim 2 wherein said first computing system further comprise a memory in communication with the at least one scheduler module of the first computing system and the at least one post-processing module of the first computing system.

7. The system of claim 1 wherein said at least one security module comprises one or more processing cores configured to perform network security functions.

8. The system of claim 7 wherein said processing cores include one or more processing units disposed in a central processing unit (CPU).

9. The system of claim 7 wherein said processing cores include fragment processors disposed in a graphics processing unit (GPU).

10. The system of claim 7 wherein said processing cores vertex processors disposed in a graphics processing unit (GPU).

11. The system of claim 1 wherein said at least one scheduler module is disposed in part in a graphics processing unit (GPU).

12. The system of claim 1 wherein said at least one post-processing module is disposed in part in a graphics processing unit (GPU).

13. The system of claim 1 wherein said at least one security module includes dedicated network security hardware devices.

14. The system of claim 13 wherein said dedicated network security hardware devices further comprise one or more processing cores.

15. The system of claim 13 wherein said dedicated network security hardware devices include reconfigurable hardware logic.

16. The system of claim 1 wherein said one or more scheduled data streams are derived from one or more post-processed data streams.

17. A method for performing network security functions, the method comprising:
operating a network security application using a first computing system;
receiving data streams from the first computing system;
generating one or more scheduled data streams and one or more output data streams from the received data streams;
generating one or more processed data streams using the one or more schedule data streams;
post-processing the one or more processed data streams; and
outputting the post-processed data streams.

18. The method of claim 17 further comprising using processing cores for performing network security functions.

19. The method of claim 18 wherein said processing cores include processing units within a central processing unit (CPU).

20. The method of claim 18 wherein said processing cores include fragment processors disposed in a graphics processing unit (GPU).

21. The method of claim 18 wherein said processing cores include vertex processors disposed in a graphics processing unit (GPU).

22. The method of claim 17 wherein the one or more scheduled data streams are derived from one or more post-processed data streams.

23. The method of claim 22 further comprising using processing cores for performing network security functions.

24. The method of claim 23 wherein said processing cores include processing units within a central processing unit (CPU).

25. The method of claim 23 wherein said processing cores include fragment processors disposed in a graphics processing unit (GPU).

26. The method of claim 23 wherein said processing cores include vertex processors disposed in a graphics processing unit (GPU)

27. A method for performing network security functions, the method comprising:
receiving input data streams from a network security application;
processing the input data streams to generate processed input data streams;
selectively scheduling the processed input data streams to generate scheduled data streams; and
performing security operation on the scheduled data streams.

28. The method of claim 27 wherein the processing of data streams comprises one of disassembling or transforming of data streams.

29. The method of claim 27 further comprising:
processing the scheduled data streams to generate one of partially post-processed data stream or fully post-processed data stream;
selectively scheduling the partially post-processed data stream or fully post-processed data stream to generate twice scheduled data streams; and
performing security operation on the twice scheduled data streams.

30. The method of claim 27 further comprising using processing cores for receiving the input data streams.

31. The method of claim 30 further comprising using processing cores for generating partially processed data streams.

32. The method of claim 31 further comprising using processing cores for generating fully processed data streams.

33. The method of claim 32 wherein said processing cores include processing units within a central processing unit (CPU).

34. The method of claim 32 wherein said processing cores include fragment processors disposed in a graphics processing unit (GPU).

35. The method of claim 32 wherein said processing cores include vertex processors disposed in a graphics processing unit (GPU).
